(19) United States
(12) Patent Application Publication
(10) Pub. No.: US 2015/0029029 A1
(43) Pub. Date: Jan. 29, 2015

(54) ACCELEROMETERS IN AN AREA

(71) Applicants: Matthew Alan Hopcroft, San Francisco, CA (US); Jerome Rolia, Kanata (CA); Sharad Singhal, Belmont, CA (US); Charles Edgar Bess, Frisco, TX (US); Henri J. Suermondt, Sunnyvale, CA (US)

(72) Inventors: Matthew Alan Hopcroft, San Francisco, CA (US); Jerome Rolia, Kanata (CA); Sharad Singhal, Belmont, CA (US); Charles Edgar Bess, Frisco, TX (US); Henri J. Suermondt, Sunnyvale, CA (US)

(21) Appl. No.: 14/344,862

(22) PCT Filed: Sep. 29, 2011
(86) PCT No.: PCT/US11/54062

§ 371 Date: Mar. 13, 2014

Related U.S. Application Data
(60) Provisional application No. 61/534,877, filed on Sep. 14, 2011.

(51) Int. Cl. G08B 21/22

(52) U.S. Cl. CPC G08B 21/22
USPC 340/573.4

(57) ABSTRACT

A system includes a patient environment in an area, a first accelerometer attached to the first patient environment, a second accelerometer disposed in the area, and a processing system to detect an activity of a patient in the area using vibration data received from the first and the second accelerometers.

### BACKGROUND

Health care providers may periodically monitor the private or shared areas of patients, either in person or using instruments such as microphones or cameras. The monitoring is generally expensive and often invades the privacy of patients. In some cases, patients may carry devices that alert care providers if they fall or are otherwise in trouble. However, patients may forget or choose not to carry such devices or may not be in a state that enables them to activate such devices.

### BRIEF DESCRIPTION OF THE DRAWINGS

FIGS. 1A-1B are schematic diagrams illustrating embodiments of accelerometers disposed in patient environments and areas.

FIGS. 2A-2C are schematic diagrams illustrating embodiments of capturing vibration data in an area.

FIG. 3 is a flow chart illustrating one embodiment of a method for capturing and providing vibration data with an accelerometer.

FIG. 4 is a signal diagram illustrating one embodiment of vibration data captured by an accelerometer.

FIG. 5 is a flow chart illustrating one embodiment of a method for processing vibration data from accelerometers.

FIG. 6 is a block diagram illustrating one embodiment of a processing environment.

### DETAILED DESCRIPTION

In the following detailed description, reference is made to the accompanying drawings which form a part hereof, and in which is shown by way of illustration specific embodiments in which the disclosed subject matter may be practiced. It is to be understood that other embodiments may be utilized and structural or logical changes may be made without departing from the scope of the present disclosure. The following detailed description, therefore, is not to be taken in a limiting sense, and the scope of the present disclosure is defined by the appended claims.

As described herein, a system includes highly sensitive accelerometers disposed in multiple locations in the area of a patient. The accelerometers may be attached (e.g. mounted) to patient environments (e.g., a bed, a chair, a wheelchair, or an examination table) or to other structures in the area such as the wall, floor, or other furniture or items in the area. The accelerometers each provide vibration data to a processing system which extracts information for detecting activities of the patient or others in the area that may not otherwise be detectable using an individual accelerometer. The accelerometers form a data network that enables the processing system to correlate and analyze the vibration data from the accelerometers simultaneously. The activities detected from the vibration data by the processing system supports the care of patients where the system is employed.

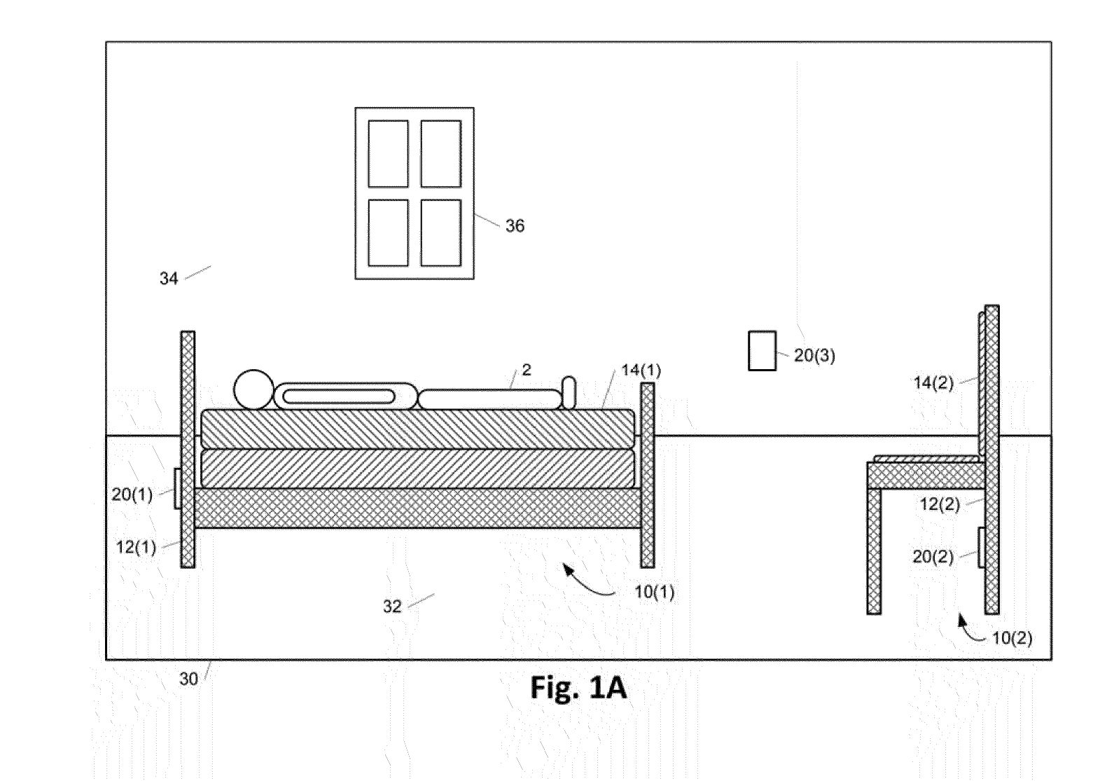

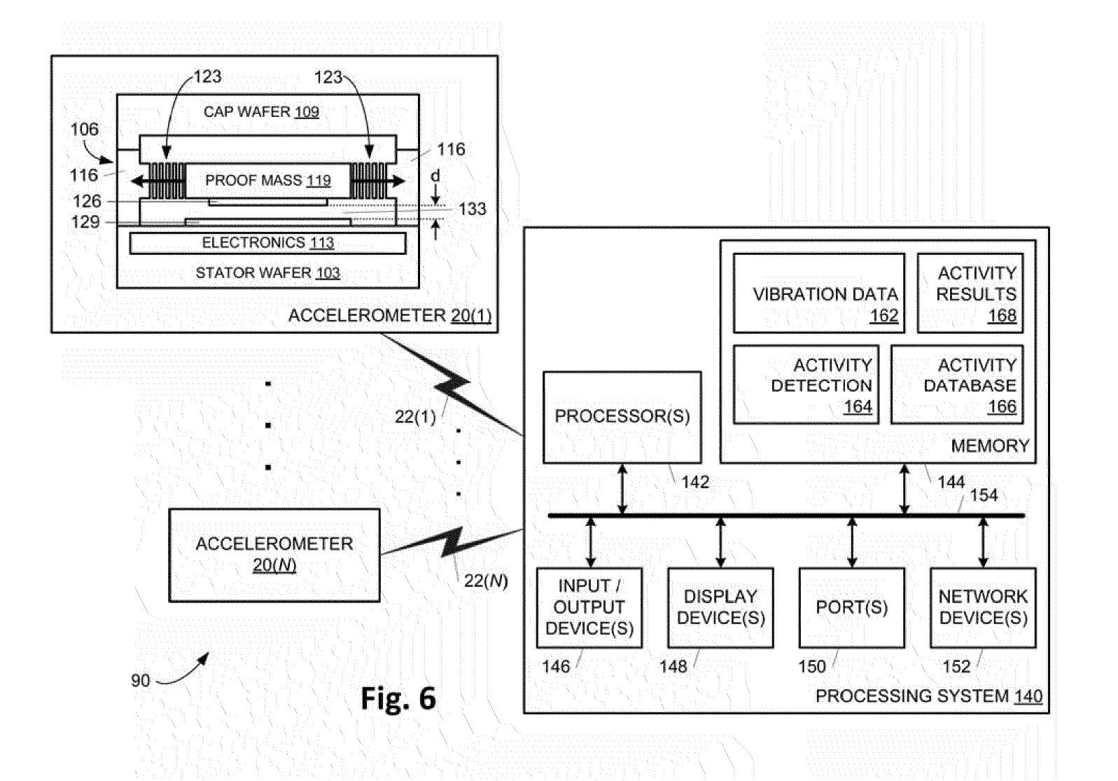

As used herein, the term patient environment includes a bed, chair, wheelchair, an examination table, or other suitable apparatus with one or more support-surfaces configured for a patient to assume a relatively stationary position (e.g., lying and/or sitting). FIGS. 1A-1B are schematic diagrams illustrating embodiments of accelerometers 20 disposed in patient environments 10 and areas 30. Each accelerometer 20 captures vibration data and provides the vibration data to one or more processing systems, such as a processing system 140 shown in FIG. 6 and described in additional detail below, for detection of activities that occur in area 30. As used herein, vibration data refers to a set of data values that collectively represent the frequency and amplitude of the vibrations detected by an accelerometer 20 over time. Each area 30 may be located in a health care facility, a home, or other suitable location and may be adjacent or in proximity to other areas 30 with one or more patient environments 10 and/or accelerometers 20.

As used herein, the term activities refers to the actions of one or more patients 2 or others in or near an area 30 that generate vibrations that transmit through materials in area 30 to one of more accelerometers 20. The materials include structural elements that form area 30 soon as a floor 32, walls 34, a ceiling (not shown), windows 36, and doors 38, materials that comprise patient environments 10, and other objects (e.g., medical equipment or home furnishings) present in area 30 (not shown).

For a patient 2 in direct contact with a patient environment 10 with an accelerometer 20, accelerometer 20 also captures physiological data from the vibrations generated by the internal and external body functions of patient 2 as part of the vibration data. The human body can be described as a mechanical system win thousands of moving parts where every one of the parts can create a mechanical vibration from muscle movements or other body functions. These mechanical vibrations result from internal body functions such as the rise and fall of a chest during breathing and the beating of a heart. These mechanical vibrations also result from external motions such as muscle tremors or turning over during sleep. Many of the vibrations of a body are extremely small and/or occur slowly.

As used herein, direct contact with regard to patient 2 refers to a physical connection of at least a portion of the body of patient 2 with a surface 14 of a patient environment 10. Patient 2 includes any clothing or other garments worn on the body, and surface 14 may include any bedding, cushions, upholstery, or other material that is exposed on surface 14. The direct contact of patient 2 way involve the clothing and/or skin of the patient 2 physically touching the bedding, cushions, upholstery, or other material on surface 14 to cause vibrations from internal and external body motions of patient 2 to transfer from patient 2 to surface 14.

When in direct contact with a patient environment 10 (e.g., attached to a patient environment 10), accelerometer 20 captures, as part of the vibration data, physiological data that represents the vibrations generated by patient 2 on patient environment 10 and transmitted to accelerometer 20 through the patient environment 10. From the physiological data, a processing system, such as processing system 140, may determine a range of health information including heart rate, respiration rate, and other specific features in the physiological data.

As used herein, direct contact with regard to accelerometer 20 refers to a physical connection of at least a portion of accelerometer 20 with a surface 12 of a patient environment 10 or another surface such as a floor 32 or a wall 34. Each accelerometer 20 includes any housing (not shown) that contains or supports the accelerometer 20 any materials (not shown) used to attach or mount accelerometer 20 to a surface. Accordingly, the direct contact of accelerometer 20 may involve the housing or materials used to attach or mount accelerometer 20 physically touching the surface to allow vibrations from internal and external body motions of patient 2 to transfer from surface 14, as well as other surfaces, to accelerometer 20.

Accelerometer 20 includes ultra-high sensitivity microfabricated accelerometer technology with three-phase sensing as described by U.S. Pat. Nos. 6,882,019, 7,142,500, and 7,484,411 and incorporated by reference herein in their entirety. Accelerometer 20 is a sensor which detects acceleration, i.e., a change in a rate of motion, with a high sensitivity and dynamic range. Because of the three-phase sensing technology, accelerometer 20 may sense acceleration levels as low as 10's of nano-gravities (ng) and may be manufactured and housed in a device that has typical dimensions of 5×5×0.5 mm or less using Micro-Electro-Mechanical-Systems (MEMS) technology. The combination of high sensitivity and small device size enabled by three-phase sensing techniques allows accelerometer 20 to unobtrusively capture physiological data transmitted from a patient 2 through a patient environment 10 without direct contact between any portion of accelerometer 20 and patient 2. In addition, the sensitivity of accelerometer 20 allows physiological data to be captured such that specific features of physiological conditions of patient 2 can be detected by a processing system. These features include not only cardiac pulse and respiratory rate but specific conditions such as arrhythmia. Additional details of accelerometer 20 are shown and described with reference to FIG. 6 below.

In FIG. 1A, area 30 includes patient environments 10(1) and 10(2) which form a bed and a chair, respectively, disposed in different locations in area 30. The bed includes a frame, box spring, a mattress, and bedding (not shown) that transmit vibrations of patient 2 from a surface 14(1) in direct contact with patient 2 (i.e., the top surface of the mattress) to a surface 12(1) of the bed frame on which accelerometer 20(1) is directly connected. Accelerometer 20(1) captures vibration data from the vibrations transmitted from surface 14(1) and floor 32 through the mattress, box spring, and bed frame (i.e., a plurality of materials) to surface 12(1) (i.e. vibrations in proximity to the location of accelerometer 20(1) in area 30). The vibration data may include physiological data of patient 2 as described above. Patient 2, when present in patient environment 10(1), is not in direct contact with surface 12(1), and no portion of accelerometer 20(1) is in direct contact with patient 2—i.e., accelerometer 20(1) does not include any wired or wireless connections to patient 2 other than through the bed itself.

The chair is in a location in area 30 removed from the bed and includes a chair frame and cushions or upholstery that, when patient 2 is present, transmit vibrations of patient 2 from a surface 14(2) an direct contact with patient 2 (i.e., the top surface of the cushions or upholstery) to a surface 12(2) of the chair frame on which accelerometer 20(2) is directly connected. Accelerometer 20(2) captures vibration data from the vibrations transmitted from surface 14(2) and floor 32 through the cushions or upholstery and chair frame (i.e., a plurality of materials) to surface 12(2) (i.e., vibrations in proximity to the location of accelerometer 20(2) in area 30). The vibration data may include physiological data of patient 2 as described above. Patient 2, when present in patient environment 10(2), is not in direct contact with surface 12(2), and no portion of accelerometer 20(2) is in direct contact with patient 2—i.e., accelerometer 20(2) does not include any wired or wireless connections to patient 2 other than through the chair itself.

The structural elements of area 30 and/or other objects (e.g., medical equipment or home furnishings) present so area 30 (not shown) may also include one or more accelerometers 20 disposed in various locations in area 30. Accelerometer 20(3) is shown attached to wall 34 in the example of FIG. 1A. Accelerometer 20(3) captures vibration data from the vibrations transmitted through wall 34 and/or other structural elements of area 30 (i.e., vibrations in proximity to the location of accelerometer 20(3) in area 30).

FIG. 1B illustrates an arbitrary plurality of areas 30 (e.g., rooms) in proximity and adjacent to one another. As shown in FIG. 1B, each area 30 may include any suitable number of patient environments 10 and accelerometers 20. Each accelerometer 20 may be attached to a patient environment 10, a structural element of area 30 (e.g., a wall 34), or another object present in an area 30. Each accelerometer 20 captures vibration data representing the vibrations detected in proximity to the accelerometer 20 and provides the vibration data to one or more processing systems (e.g., processing system 140 shown in FIG. 6).

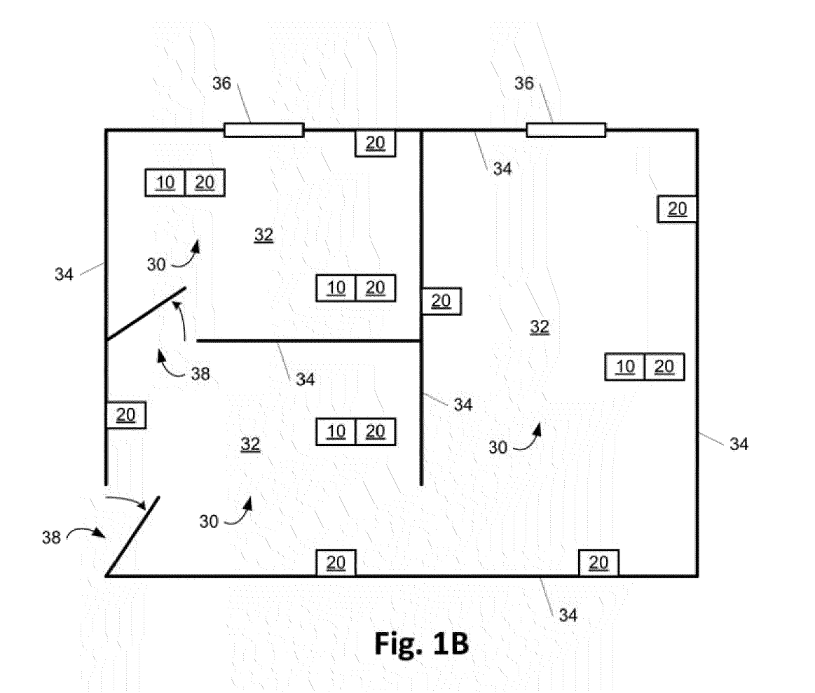

FIGS. 2A-2C are schematic diagrams illustrating embodiments of capturing vibration data in an area.

FIG. 2A illustrates an accelerometer 20 attached to a patient environment 10 where the transmission of vibrations 42 of patient 2 are captured by accelerometer 20 as vibration data 44 as indicated by an arrow 46. In particular, patient 2 generates vibrations 42 which are transferred to a surface 14 in direct contact with patient 2. Surface 14 transfers vibrations 42 though a plurality of materials 16 of patient environment 10 to surface 12. Plurality of materials 16 is disposed between surface 14 and surface 12 and includes any suitable typo and combination of materials for patient environment 10 as set forth by embodiments 10(1) and 10(2) described above. Surface 12 transfers vibrations 42 to accelerometer 20 where vibrations 32 are captured as vibration data 44 and provided to a processing system over any suitable wired or wireless connection 22.

FIG. 2B illustrates an accelerometer 20 attached to a patient environment 10 where the transmission of vibrations 48 from structural elements of area 30 (e.g., floor 32) are captured by accelerometer 20 as vibration data 50 as indicated by an arrow 52. In particular, vibrations from area 30 are transferred to patient environment 10 and then to accelerometer 20 where vibrations 48 are captured as violation data 50 and provided to a processing system over any suitable wired or wireless connection 22. Vibration data 50 may be captured by accelerometer 20 in addition to vibration data 44 (FIG. 2A) when a patient 2 is present in patient environment 10.

FIG. 2C illustrates an accelerometer 20 attached to one or more structural elements of area 30 where the transmission of vibrations 54 from the structural elements of area 30 (e.g., wall 34) are captured by accelerometer 20 as vibration data 56 as indicated by an arrow 58. In particular, vibrations from area 30 are transferred to accelerometer 20 where vibrations 54 are captured as vibration data 56 and provided to a processing system over any suitable wired or wireless connection 22.

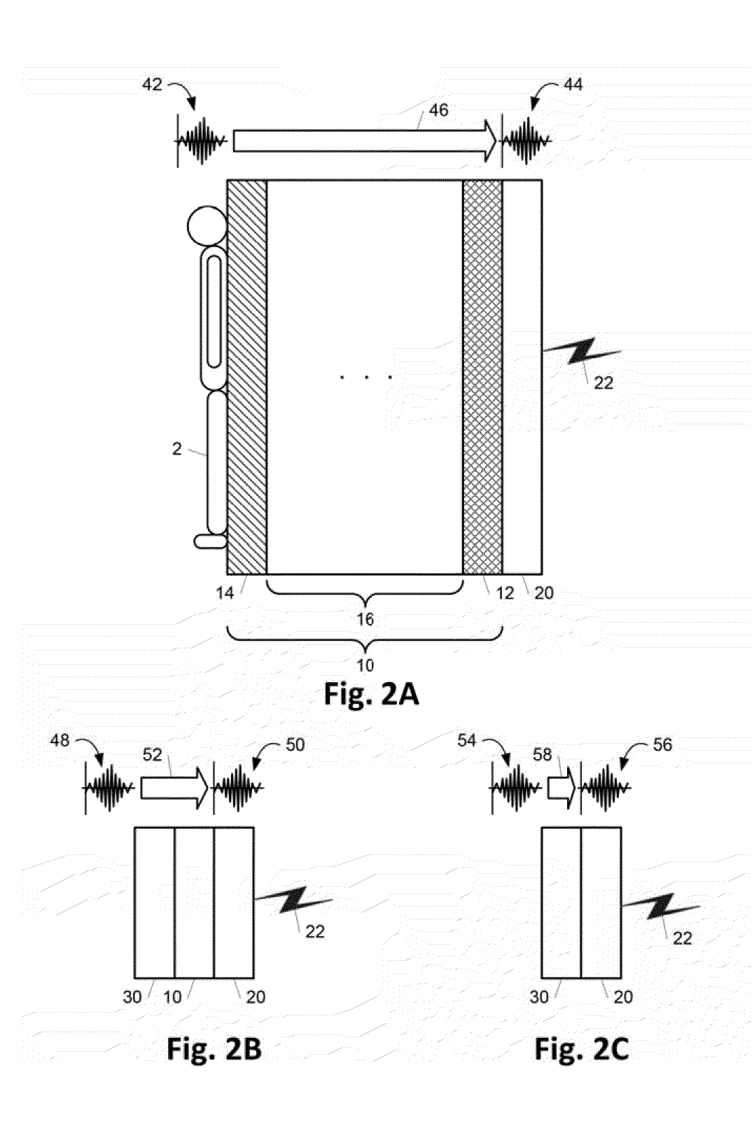

The functions of accelerometer 20 are further illustrated in FIG. 3 which is a flow chart illustrating one embodiment of a method for capturing and providing vibration data with an accelerometer 20. Each accelerometer 20 in an area 30 performs the method shown in FIG. 3 in one embodiment. In FIG. 3, accelerometer 20 captures vibration data in an area 30 as indicated in a block 62. The vibration data may include physiological data that is transmitted from patient 2 through a plurality of materials of a patient environment 10 before reaching accelerometer 20 as described above.

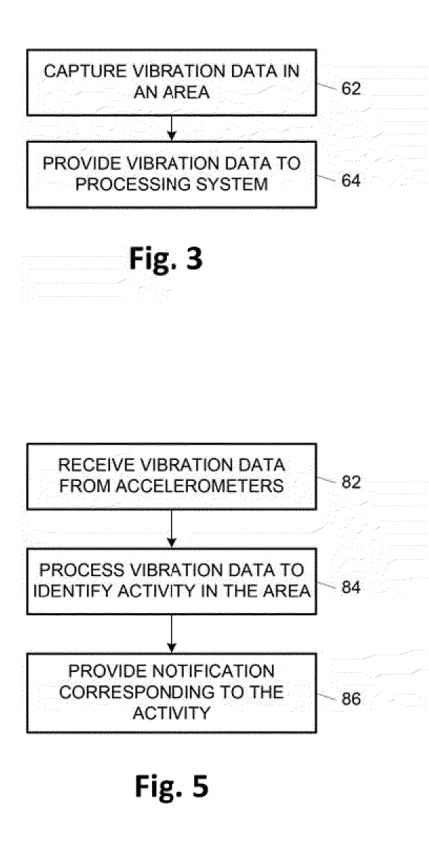

FIG. 4 is a signal diagram 70 illustrating one embodiment of vibration data 72 captured by accelerometer 20 while patient 2 is in a patient environment 10 that forms a bed (e.g., patient environment 10 shown in FIG. 1A). The amplitude of the vibrations of vibration data 72 is plotted in the y axis over time in the x axis. Various features of the health condition of patient 2 appear in vibration data 72. For example, the pulse rate is apparent in a portion 72A of data 72. Activities of patient 2 such as rolling over, exiting the bed, and folding blankets on the bed are apparent in portions 72B, 72C, and 72D of data 72, respectively. Other activities such as a door closing and footsteps occurring near the bed are apparent in portions 72E and 72F of data 72, respectively.

The typical level of the vibrations detected by accelerometer 20 in this example is a few μg (i.e., 1×10⁻⁶ g). Accordingly, vibration data 72 includes features present only in data captured by a high sensitivity accelerometer 20. Vibration data 72 data can be analyzed by a processing system using time and/or frequency domain information and correlated by the processing system to identify activities of patient 2 or others in an area 30.

Referring back to FIG. 3, accelerometer 20 provides the vibration data to a processing system as indicated in a block 64. Accelerometer 20 may provide vibration data to the processing system by continuously transferring the data to the processing system or by storing the data in computer readable medium (not shown) for periodic transmittal or retrieval by the processing system. Accelerometer 20 may provide the physiological data to a processing system using any suitable type of wired and/or wireless connection 22 which is described in additional detail below with reference to FIG. 6.

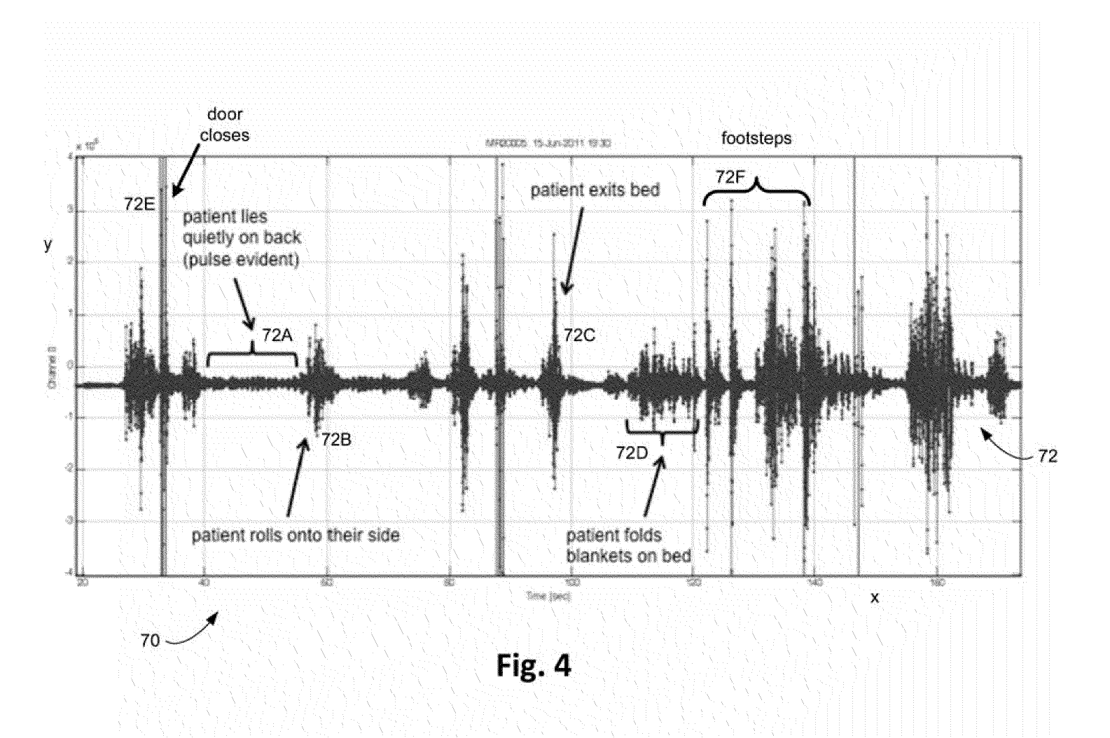

The functions of one or more processing systems (e.g., processing system 140 shown in FIG. 6) are illustrated in FIG. 5 which is a low chart illustrating one embodiment of a method for processing vibration data from accelerometers 20. The method of FIG. 5 will be described with reference to processing system 140 shown in FIG. 6.

In FIG. 5, processing system 140 receives vibration data from accelerometers 20 in one or more areas 30 as indicated in a block 82. Processing system 140 may receive the data as continuous or periodic streams from accelerometers 20 or may retrieve the data by accessing the data from computer readable media (not shown) of the accelerometers 20. Processing system 140 processes the vibration data to identity activity in an area or areas 30 as indicated in a block 84. Processing system 140 may use frequency domain or time domain analysis on the vibration data from the various accelerometers and correlate the analyses to identify the activity. Processing system 140 may also detect activity by correlating known patterns from an activity database (e.g., activity database 166 shown in FIG. 6) with activity in the vibration data. By doing so, processing system 140 may comparing an activity from the vibration data to an expected behavior of a patient 2 to detect deviations from the an expected behavior of the patient 2. The expected behavior may be stored as part of the activity database.

Processing system 140 provides a notification corresponding to the identified activity as indicated in a block 86. Processing system 140 may provide the notification to patient 2 or any suitable interested person associated wife patient 2 such as a health care professional or family, friends, or others having a relationship with patient 2. Processing system 140 may provide notifications at any suitable time and in any suitable way. For example, processing system 140 may provide an immediate notification by displaying the activity, an identification of the activity, or a notice that an activity of interest has been detected to an interested person. Processing system 140 may also store a log or other report of identified activities (e.g., activity results 168 shown in FIG. 6) for later retrieval by an interest person.

Examples of activities detected and notifications by processing system 140 using the vibration data will now be described. In a first example, processing system 140 identifies activities that estimate a location of a patient 2 or other person in an area 30. Processing system 140 may continually estimate the location of patient 2 as the patient 2 moves through one or more areas 30. If a patient 2 becomes immobile at an unexpected location in an area 30, then processing system 140 may detect the activity (i.e., the mobility followed by the immobility at an unexpected location) and notify a health care professional that can attempt to communicate with patient 2. The health care professional may take further action if no response from patient 2 is received.

In another example, processing system 140 may be provided with information about the location and function of areas 30 in an activity database (e.g., activity database 166 shown in FIG. 6). Using the database, processing system 140 may infer how often a patient 2 is using a particular area 30. For example, processing system 140 may make inferences about washarea, kitchen, and bath/shower use. If a pattern of use by patient 2 changes significantly, processing system 140 may notify a health care professional.

In a further example, processing system 140 may enhance the security of a patient 2 using an awareness of the patient's schedule in the activity database. Processing system 140 may determine whether additional persons are present in an area 30 when or where they are not expected. Processing system 140 may also infer whether exit doors or windows are opened and closed at unexpected times or whether the patient leaves an area 30 unexpectedly. In the case of unexpected situations, processing system 140 may contact the patient 2 and/or a health care professional to confirm the security of patient 2.

Still further, processing system 140 may detect the presence and kinds of pets in an area may be identified. Such detection may be used to distinguish patient and pet activities.

Processing system 140 may be configured according to a set of reporting policies that determine how notifications of identified activities are disseminated. The notifications may be reported to entities such as the patient family members, a health care professional, security personnel, other care providers, and/or medical record systems. Policies may be used by processing system 140 to limit the reporting of information for each entity. For example, for some patients an entity may be notified when any unexpected activity occurs. Other entities may receive notifications only after that one or more attempts to contact the patient by one or more other entities are unsuccessful. The notifications may include comparisons with other patients with similar demographics, also observed using accelerometers 20 as described above.

FIG. 6 is a block diagram illustrating one embodiment of a processing environment 90. Processing environment 90 includes accelerometers 20(1)-20(N), where N is an integer greater than or equal to two, in communication with processing system 140 across respective connections 22(1)-22(N).

In the discussion below, accelerometer 20 refers to each accelerometer 20(1)-2(N) individually and accelerometers 20 refer to accelerometers 20(1)-20(N) collectively. Connection 22 refers to each connection 22(1)-22(N) individually and connections 22 refer to connections 22(1)-22(N) collectively.

In the embodiment of FIG. 6, accelerometer 20 includes three layers, or “wafers.” In particular, each accelerometer 20 includes a stator wafer 103, a rotor wafer 106, and a cap wafer 109. Stator wafer 103 includes electronics 113 that may be electrically coupled to various electrical components in rotor wafer 106 and cap wafer 109. Also, electronics 113 may provide output ports for coupling to electronic components external to accelerometer 20.

Rotor wafer 106 includes support 116 that is mechanically coupled to a proof mass 119. Although the cross-sectional view of accelerometer 20 is shown, according to one embodiment, support 116 as a portion of rotor wafer 106 surrounds proof mass 119. Consequently, in one embodiment, stator wafer 103, support 116, and cap wafer 109 form a pocket within which proof mass 119 is suspended.

Together, stator wafer 103, support 116, and cap wafer 109 provide a support structure to which proof mass 119 is attached via a compliant coupling. The compliant coupling may, in one embodiment, comprise high aspect ratio flexural suspension elements 123 described in U.S. Pat. No. 6,882,019.

Accelerometer 20 further includes a first electrode array 126 that is disposed on proof mass 119. In one embodiment first electrode array 126 is located on a surface of proof mass 119 that is opposite the upper surface of stator wafer 103. The surface of the proof mass 119 upon which the first electrode array 126 is disposed is a substantially flat surface.

A second electrode array 129 is disposed on a surface of stator wafer 103 facing opposite first electrode array 126 disposed on proof mass 119. Because proof mass 126 is suspended over stator wafer 103, a substantially uniform gap 133 (denoted by d) is formed between first electrode array 126 and second electrode array 129. The distance d may comprise, for example, anywhere from 1 to 3 micrometers, or it may be another suitable distance.

Proof mass 119 is suspended above stator wafer 103 so that first electrode array 126 and second electrode array 129 substantially fall into planes that are parallel to each other and gap 133 is substantially uniform throughout the overlap between first and second electrode arrays 126 and 129. In other embodiments, electrode arrays 126 and 129 may be placed on other surfaces or structures of stator wafer 103 or proof mass 119.

High aspect ratio flexural suspension elements 123 offer a degree of compliance that allows proof mass 119 to move relative to the support structure of accelerometer 20 (not show). Due to the design of flexural suspension elements 123, the displacement of proof mass 119 from a rest position is substantially restricted to a direction that is substantially parallel to second electrode array 129, which is disposed on the upper surface of stator wafer 103. Flexural suspension elements 123 are configured to allow for a predefined amount of movement of proof mass 119 in a direction parallel to second electrode array 129 such that gap 133 remains substantially uniform throughout the entire motion to the extent possible. The design of flexural suspension elements 123 provides for a minimum amount of motion of proof mass 119 in a direction orthogonal to second electrode array 129 while allowing a desired amount of motion in the direction parallel to second electrode array 129.

As proof mass 119 moves capacitances between first and second electrode arrays 126 and 129 vary with the shifting of the arrays with respect to each other. Electronics 113 and/or external electronics are employed to detect or sense the degree of the change in the capacitances between electrode arrays 126 and 129. Baaed upon the change in the capacitances, such circuitry can generate appropriate signals that are proportional to the vibrations from patient 2 experienced by accelerometer 20.

The operation of accelerometer 20 is enhanced by the use of three-phase sensing and actuation as described by U.S. Pat. Nos. 6,862,019 and 7,484,411. Three-phase sensing uses an arrangement of sensing electrodes 126 and 129 and sensing electronics 113 to enhance the output signal of accelerometer 20 and allow for the sensitivity to be maximized in a desired range. It also allows the output of accelerometer 20 to be “reset” to zero electronically when the sensor is in any arbitrary orientation.

Processing system 140 represents any suitable processing device, or portion of a processing device, configured to implement the functions of the method shown in FIG. 5 and described above. A processing device may be a laptop computer, a tablet computer, a desktop computer, a server, or another suitable type of computer system. A processing device may also be a mobile telephone with processing capabilities (i.e., a smart phone) or another suitable type of electronic device with processing capabilities. Processing capabilities refer to the ability of a device to execute instructions stored in a memory 144 with at least one processor 142. Processing system 140 represents one of a plurality of processing systems in a cloud computing environment in one embodiment.

Processing system 140 includes at least one processor 142 configured to execute machine readable instructions stored in a memory system 144. Processing system 140 may execute a basic input output system (BIOS), firmware, an operating system, a runtime execution environment, and/or other services and/or applications stored in memory 144 (not shown) that includes machine readable instructions that are executable by processors 142 to manage the components of processing system 140 and provide a set of functions that allow other programs to access and use the components. Processing system 140 stores vibration data 162 received from accelerometers 20 in memory system 144 along with an activity detection unit 164 that performs the method of FIG. 5 described above. Processing system 140 further stores an activity database 166 and activity results 168 in some embodiments.

Processing system 140 may also include any suitable number of input/output devices 146, display devices 148, ports 150, and/or network devices 152. Processors 142, memory system 144, input/output devices 146, display devices 148, ports 150, and network devices 152 communicate using a set of interconnections 154 that includes any suitable type, number, and/or configuration of controllers, buses, interfaces, and/or other wired or wireless connections. Components of processing system 140 (for example, processors 142, memory system 144, input/output devices 146, display devices 148, ports 150, network devices 152, and interconnections 154) may be contained in a common housing with accelerometer 20 (not shown) or in any suitable number of separate housings separate from accelerometer 20 (not shown).

Each processor 142 is configured to access and execute instructions stored in memory system 144 including activity detection unit 164. Each processor 142 may execute the instructions in conjunction with or in response to information received from input/output devices 146, display devices 148, ports 150, and/or network devices 152. Each processor 142 is also configured to access and store data, including vibration data 162, activity database 166, and activity results 168, in memory system 144.

Memory system 144 includes any suitable type, number, and configuration of volatile or non-volatile storage devices configured to store instructions and data. The storage devices of memory system 144 represent computer readable storage media that store computer-readable and computer-executable instructions including activity detection unit 164. Memory system 144 stores instructions and data received from processors 142, input/output devices 146, display devices 148, ports 150, and network devices 152. Memory system 144 provides stored instructions and data to processors 142, input/output devices 146, display devices 148, ports 150, and network devices 152. Examples of storage devices in memory system 144 include hard disk drives, random access memory (RAM), read only memory (ROM), flash memory drives and cards, and other suitable types of magnetic and/or optical disks.

Input/output devices 146 include any suitable type, number, and configuration of input/output devices configured to input instructions and/or data from a user to processing system 140 and output instructions and/or data from processing system 140 to the user. Examples of input/output devices 146 include a touchscreen, buttons, dials, knobs, switches, a keyboard, a mouse, and a touchpad.

Display devices 148 include any suitable type, number, and configuration of display devices configured to output image, textual, and/or graphical information to a user of processing system 140. Examples of display devices 148 include a display screen, a monitor, and a projector. Ports 150 include suitable type, number, and configuration of ports configured to input instructions and/or data from another device (not shown) to processing system 140 and output instructions and/or data from processing system 140 to another device.

Network devices 152 include any suitable type, number, and/or configuration of network devices configured to allow processing system 140 to communicate across one or more wired or wireless networks (not shown). Network devices 152 may operate according to any suitable networking protocol and/or configuration to allow information to be transmitted by processing system 140 to a network or received by processing system 152 from a network.

Connection 22 includes any suitable type and combination of wired and/or wireless connections that allow accelerometer 20 to provide vibration data 162 to processing system 140. Connection 22 may connect to one or more ports and/or one or more network devices 152 of processing system 140. For example, connection 22 may comprise a wireless network connection that includes a wireless network device (not shown) that transmits vibration data 162 from accelerometer 20 to processing system 140. As another example, connection 22 may comprise a cable connected from accelerometer 20 to a port 150 to transmit vibration data 162 from accelerometer 20 to processing system 140.

Referring back to FIGS. 1A-1B and 2A-2C, an optimal placement of accelerometers 20 may be determined using various methods to allow increase the detectability of vibration data 162 by accelerometers 20. In at least some of the methods, accelerometers 20 are initially affixed at one location and then signals are observed at accelerometers 20. Accelerometers 20 are then affixed at one or more different locations and the signals observed again at accelerometers 20. An adjustable clamp (not shown) may be used to temporarily affix accelerometers 20.

In one method, the natural resonance of patient environment 10 is measured by accelerometers 20 without any simulated external stimulation. Patient environment 10, including the materials therein, may act to amplify or attenuate different aspects of signals. The locations of accelerometer 20 that provide the best signal reception or the least disruption at frequencies of interest may be selected as the optimal locations.

In another method, a vibration simulator is employed to provide known stimulus to a location or a patient environment 10. The stimulus may represent a particular waveform such as a sine wave. Such a wave can be used to find a location for accelerometers 20 that causes the least interference with the signal. Alternatively, the simulator may mimic waveforms that correspond to specific patient features to be identified from physiological data. The locations of accelerometer 20 that cause the least interference with the signal or that lead to the best quality of specific patient features may be selected as the optimal locations.

When repeatedly moving the locations of accelerometers 20, care may be taken to place accelerometers 20 at discrete intervals that correspond to the dimension of accelerometers 20. Joints and midpoints between joints of patient environment 10 may be considered. By doing so, all possible resonance behaviors may be observed.

Accelerometers 20 and processing system 140 may also be used to capture of additional information for calibrating or training activity detection unit 164 according to various techniques. Processing system 140 may be provided with information about the layout of an area 30 using accelerometers 20. For example, a device with a known vibration signal may be used to mark the location of doors, windows, areas such as kitchens and bathareas, and fixtures such as beds, sofas and toilets. Patients may be asked to perform a series of activities that include activities of interest such as opening and closing doors or windows. Accelerometers 20 capture the vibration data of these activities to allow processing system 140 to correlate the vibration data with the activities in activity database 166.

The above embodiments may advantageously enable non-intrusive, continuous, long-term, inexpensive monitoring of activities in a patient area which may otherwise be difficult or time consuming for health care personnel to make. The embodiments may also provide the ability to communicate results to interested persons based on configurable policies. This may allow the above embodiments to participate in health care processes for patients in an active and timely manner.

Although specific embodiments have been illustrated and described herein for purposes of description of the embodiments, it will be appreciated by those of ordinary skill in the art that a wide variety of alternate and/or equivalent implementations may be substituted for the specific embodiments shown and described without departing from the scope of the present disclosure. Those with skill in the art will readily appreciate that the present disclosure may be implemented in a very wide variety of embodiments. This application is intended to cover any adaptations or variations of the disclosed embodiments discussed herein. Therefore, it is manifestly intended that the scope of the present disclosure be limited by the claims and the equivalents thereof.

What is claimed is:

1. A system comprising:
a first patient environment disposed in a first location in an area;
a first accelerometer attached to the first patient environment, the first accelerometer to capture first vibration data in proximity to the first location;
a second accelerometer disposed in a second location in the area that is removed from the first patient environment, the second accelerometer to capture second vibration data in proximity to the second location; and
a processing system to detect an activity in the area using the first and the second vibration data received from the first and the second accelerometers, respectively.

2. The system of claim 1 wherein the processing system is to generate a notification corresponding to the activity.

3. The system of claim 2 wherein the processing system is to generate the notification in response to determining that the activity deviates from an expected behavior of a patient.

4. The system of claim 1 wherein the processing system is to estimate a location of a patient in the area based on the activity.

5. The system of claim 1 wherein the first vibration data includes physiological data of a patient in response to the patient being in contact with the first patient environment.

6. The system of claim 4 wherein the physiological date represents internal and external body movements of the patient transmitted through the patient environment.

7. The system of claim 1 further comprising:
a second patient environment;
wherein the second accelerometer is attached to the second patient environment.

8. The system of claim 1 wherein the patient environment includes one of a bed or a chair.

9. The system of claim 1 wherein the first accelerometer includes a proof mass with a first electrode array suspended above a second electrode array disposed on a wafer.

10. A method performed by a processing system, the method comprising:
receiving, at the processing system, first vibration data from a first accelerometer in direct contact with a patient environment in an area and second vibration data from a second accelerometer disposed in the area;
processing, at the processing system, the first and the second vibration data to identify an activity; and
providing, at the processing system, a notification corresponding to the activity.

11. The method of claim 10 further comprising:
providing the notification to at least one of a patient or a healthcare professional.

12. The method of claim 10 further comprising:
comparing the activity to an expected behavior of a patient; and
providing the notification in response to the activity deviating from the expected behavior.

13. The method of claim 10 further comprising:
estimating a location of a patient in the area based on the activity.

14. A system comprising:
a first plurality of accelerometers disposed in a first area, each of the plurality of accelerometers to capture vibration data from the first area;
a second plurality of accelerometers disposed in a second area in proximity to the first area, each of the plurality of accelerometers to capture vibration data from the first area; and
a processing system to detect a plurality of activities in the first and the second areas using the vibration data captured by the first and the second pluralities of accelerometers.

15. The system of claim 14 further comprising:
a patient environment disposed in the first area;
wherein one of the first plurality of accelerometers is attached to the patient environment.
